(19) United States
(12) Patent Application Publication
(10) Pub. No.: US 2014/0341408 A1
(43) Pub. Date: Nov. 20, 2014

(54) METHOD AND APPARATUS FOR CONVEYING INFORMATION FROM HOME APPLIANCES TO A HEARING ASSISTANCE DEVICE

(71) Applicant: Starkey Laboratories, Inc., Eden Prairie, MN (US)

(72) Inventors: Preetham Varghese, Eden Prairie, MN (US); Jeffrey Paul Solum, Shorewood, MN (US)

(21) Appl. No.: 14/450,041

(22) Filed: Aug. 1, 2014

Related U.S. Application Data
(63) Continuation-in-part of application No. 13/601,602, filed on Aug. 31, 2012.

(51) Int. Cl. H04R 25/00

(52) U.S. Cl. CPC H04R 25/554
USPC 381/315

(57) ABSTRACT

Disclosed herein, among other things, are methods and apparatus for providing a gateway for a wireless hearing assistance device. One aspect of the present subject matter relates to a method for wirelessly communicating with a hearing assistance device. One or more message and alert inputs are received and the message and alert inputs are processed to obtain an output. The output is wirelessly transmitted to a hearing assistance device, and the output is configured to be played via audio to a wearer of the hearing assistance device and to interrupt a current audio stream being played to the wearer, in various embodiments. Another aspect of the present subject matter relates to the one or more message and alert inputs being received from one or more home appliances through a hub device. The output informs the wearer of the hearing assistance device of states of the one or more home appliances.

### CLAIM OF PRIORITY

The present application is a Continuation-in-Part (CIP) of and claims the benefit of priority under 35 U.S.C. §120 to U.S. application Ser. No. 13/601,602, entitled “GATEWAY FOR A WIRELESS HEARING ASSISTANCE DEVICE”, filed Aug. 31, 2012, which is incorporated by reference herein in its entirety.

### FIELD OF THE INVENTION

The present subject matter relates generally to hearing assistance devices, and in particular to a system that includes a gateway for a wireless hearing assistance device and allows information about home appliances to be communicated to the wireless hearing assistance device through the gateway.

### BACKGROUND

Modern hearing assistance devices, such as hearing aids, typically include digital electronics to enhance the wearer's listening experience. Hearing aids are electronic instruments worn in or around the ear that compensate for hearing losses by specially amplifying sound. Hearing aids use transducer and electro-mechanical components which are connected via wires to the hearing aid circuitry.

Hearing assistance devices include the capability to receive audio from a variety of sources. For example, a hearing assistance device may receive audio from a transmitter or streamer attached to a television (TV). While receiving a streaming transmission, the audio from the hearing assistance device microphone is often attenuated to enhance the listener's experience while streaming audio from a wireless device. However, a hearing impaired person that uses or wears a hearing assistance device can become involved with listening to TV programming or other streamed content and might not hear a doorbell, a fire alarm, burglar alarm, weather alert, carbon monoxide alarm, or other serious alert. Additionally, a spouse, family member or friend might want to talk to the hearing assistance device user while they are watching the TV or otherwise not paying attention. Furthermore, the hearing assistance device user when watching TV may not hear sounds generated by a home appliance to signal status of its operation. What is needed in the art is an improved system for getting an audible message to a user of a hearing assistance device that the user would otherwise not receive.

### SUMMARY

Disclosed herein, among other things, are methods and apparatus for providing a gateway for a wireless hearing assistance device.

One aspect of the present subject matter relates to an apparatus, such as a gateway, for wireless communication with a hearing assistance device. The apparatus includes one or more inputs configured to receive messages and alerts directed to a wearer of a hearing assistance device. A processor is configured to process the messages and alerts to obtain an output adapted to be played via audio to a wearer of the hearing assistance device, and to interrupt a current audio stream being played to the wearer. A wireless transmitter is configured to transmit the output to the hearing assistance device, in various embodiments.

Another aspect of the present subject matter is use in a public multi-cast system. As a wearer of a hearing assistance device comes in the vicinity of a public broadcast service, the streaming audio from the broadcast service can be transmitted via wireless link for reception, in various embodiments.

Another aspect of the present subject matter relates to a method for wirelessly communicating with a hearing assistance device. One or more message and alert inputs are received and the message and alert inputs are processed to obtain an output. The output is wirelessly transmitted to a hearing assistance device, and the output is configured to be played via audio to a wearer of the hearing assistance device and to interrupt a current audio stream being played to the wearer, in various embodiments.

Another aspect of the present subject matter relates to a system for communication between one or more home appliances and a wearer of a hearing assistance device. The system includes a hub device and a gateway device. The hub device receives status information from the one or more home appliance, produce a status signal representative of the status information, and transmit the status signal to the gateway device. The status information is indicative of a status of each home appliance of the one or more home appliance. The gateway device includes an input to receive the status signal from the hub device, a processor to process the status signal to produce an output adapted to be played via audio by the hearing assistance device to the wearer, and a wireless transmitter configured to transmit the output to the hearing assistance device.

Another aspect of the present subject matter relates to a method for providing communication from one or more home appliances to a wearer of a hearing assistance device. Status information is received from the one or more home appliances using a hub device. The status information is indicative of status of each home appliance of the one or more home appliances, and is transmitted from the hub device to a gateway device. The status information is processed using the gateway device to produce an output. The output is adapted to be played via audio by the hearing assistance device to the wearer, and is wirelessly transmitted to the hearing assistance device.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1 illustrates a block diagram of a system for wirelessly communicating with a hearing assistance device, according to one embodiment of the present subject matter.

FIG. 2 illustrates a flow diagram of a method for wirelessly communicating with a hearing assistance device, according to one embodiment of the present subject matter.

FIG. 3 illustrates a block diagram of a system providing for wireless communication from one or more home appliances to a hearing assistance device, according to one embodiment of the present subject matter.

FIG. 4 illustrates a flow diagram of a method for wireless communication from one or more home appliances to a hearing assistance device, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present subject matter relates generally to hearing assistance devices, and in particular to a gateway for a wireless hearing assistance device. The hearing assistance devices referred to herein include, but are not limited to hearing aids. One aspect of the present subject matter relates to an apparatus for wireless communication with a hearing assistance device. The apparatus includes one or more inputs configured to receive messages and alerts directed to a wearer of a hearing assistance device. A processor is configured to process the messages and alerts to obtain an output adapted to be played via audio to a wearer of the hearing assistance device, and to interrupt a current audio stream being played to the wearer. A wireless transmitter is configured to transmit the output to the hearing assistance device, in various embodiments. In still another embodiment the processor within the hearing assistance device itself is programmed to detect and process audio alarms and other audio alerts and under those circumstances can attenuate the wireless audio stream or other acoustic audio input and alert the wearer of an alarm or alert either by amplifying the alert or by playing an audio alert equivalent to the alarm or alert being acoustically played.

A hearing assistance device with wireless communication capability (or wireless hearing assistance device) allows for new services to be offered to the wireless hearing assistance device user, or wearer. The present subject matter provides for alarms, doorbells, audio messages and text messages to be sent to the hearing assistance device user. To enable these services, an entry to the wireless hearing assistance device is required. Currently a TV streamer offers a level of access into the hearing aid for remote control message forwarding. This subject matter allows for other messages, alarms and alerts to be forwarded to the hearing assistance device user. The messages and alerts are collected by a gateway device, in one embodiment. The gateway device is enabled with a wireless link to the hearing assistance device user, in various embodiments. The hearing assistance device user would receive the messages, alerts and alarms over the wireless link. The hearing assistance device would play the audible message, alert or alarm to the hearing assistance device user. In various embodiments, the gateway device has multiple inputs (wired and/or wireless) for alarms, audio input, doorbells, etc. In one embodiment, messages are sent directly to the hearing assistance device from the gateway device. Alternatively, messages can be sent from a gateway device to an accessory device which forwards the message to the hearing assistance device. In an embodiment, messages are sent from a gateway device to a TV streamer device, where they are mixed with the audio stream by a processor (such as a digital signal processor). Messages are sent via CVSD (continuously variable slope delta modulation), G.722, G.726, AAC or other appropriate audio encoding format that can be decoded by the hearing assistance device, in various embodiments.

In various embodiments, accessories such as TV streamers, wireless audio streaming devices, cell phone interfaces, remote controls, gateways and the like can incorporate a microphone input for the purpose of “listening” for alarms. Alarms such as fire, burglar, CO, etc. and alerts such as a doorbell, weather alert, etc. can be activated when a hearing aid wearer is in the process of listening to digital audio inputs from accessory devices which will further impair the user from hearing these household alarms or alerts. In addition, a user would be less likely to hear an incoming telephone call or doorbell when steaming audio via an accessory device. The wireless accessories or dedicated accessory or audio gateway type devices can be equipped with a microphone, in an embodiment. The microphone is used as an input to monitor the ambient acoustic environment to determine if an alarm is sounding. The unit can be put in a training mode before being deployed for use to “learn” the alarm sounds so that each can be distinguished and then unique alerts can be sent to the hearing aid wearer for each alarm, or a generic alert can be sent just to alert the wearer that an alarm is sounding or a phone is ringing. In various embodiments, acoustic inputs being wirelessly forwarded to hearing instruments from accessory devices. Accessory devices may include cell phones or smart phones having wireless communication capability such as 802.11 (WIFI), Bluetooth or other means of wireless communication with a hearing instrument.

It would also be possible to add this feature to hearing aids as well and bypass the accessories. While streaming, the microphone input can still be monitored for critical alarms going off in the acoustic environment, the microphone input can go active and the wireless input can be muted to help aid the patient in hearing the alarm or be alerted to the alarm. Acoustic alarms can also be translated into voice alerts for the hearing instrument wearer, in an embodiment.

A hearing impaired user of a hearing assistance device can become involved with watching TV or other content on a streamer device, and the microphone audio would be attenuated. Both of these factors make it such that the hearing assistance device user might not notice a doorbell, a fire alarm or other serious alert that the hearing assistance device user should be made aware of. Additionally, a spouse, family member or lieind might want to talk to the hearing assistance device user while they are watching the movie or otherwise not readily paying attention. The present subject matter would also allow for a method to enable a conversation with the hearing assistance device user while the person is in a stream.

The subject matter is intended to be able to get an audible message to the hearing assistance device user. The message is sent to the hearing assistance device user via the wireless link such that the signal is amplified and made audible for the hearing assistance device wearer, in various embodiments. Alternatively, the message can be relayed through a device like a streamer or other accessory, where the message can be mixed with the audio stream.

In various embodiments, a hearing impaired user might have the volume reduced on their assisted listening device, or the assisted listening device might be in a program to attenuate the hearing assistance device. When the alert comes in, the gateway can pass a data message to increase the volume of the assisted listening device to a normal level, thus overriding attenuated volume settings.

Previously, lights have been used to alert hearing impaired users to alarms or alerts. Otherwise loud volume is required to capture the audio link and to get to the hearing assistance device wearer. The previous solutions do not allow for a multitude of alerts/message sources to be funneled to the hearing assistance device user. The present subject matter allows for multiple inputs from the appropriate sources to all be collected, mixed/processed and sent to the hearing assistance device user through wireless transmission. The messages are then played via audio to the user. Using a streamer presents a new scenario where the hearing impaired might not pay attention to his or her surroundings as they might have previously. This subject matter gets the information to the hearing impaired user, promoting safety in the case of alarms or conveying information to the hearing impaired individual so that they get the message.

One embodiment of the present subject matter includes a gateway as a standalone device to receive the inputs and transmit them wirelessly to the hearing assistance device. Alternatively a computer or smart phone can be configured to accept inputs from various sources, and software on the computer can route the message to a wireless dongle or built in wireless device. The signal can then be sent to the hearing assistance device user directly or via a cellular phone/entertainment device (CPED), TV streamer or other device in wireless communication with the hearing assistance device. A CPED is used to send audio streaming or cell phone audio to the hearing assistance device user. The cell phone can also receive messages via SMS services or via Bluetooth® or other wireless interface. When a CPED is used as a gateway, the cell phone can send the message via Bluetooth® to the CPED, where it can be mixed with other audio signals and sent to the hearing assistance device. When a smart phone or cell phone is used as the gateway device, the signals can be sent directly to the hearing instrument via wireless communication such as 802.11, Bluetooth, Bluetooth low energy or other wireless means.

In various embodiments, the present subject matter provides for training the gateway device by placing the device into a learning mode for each audible alarm within the user's home. For example, the gateway device can be placed in “learn fire alarm” mode and then a fire alarm is set off using the test button on the fire alarm device. This alarm is recorded and statistics of the sound would be analyzed by the gateway device so if it heard the alarm again while in normal operation it can forward a voice command to the hearing assistance device, or it can send a fire alarm message to the hearing assistance device where a locally generated alert can be synthesized on the hearing assistance device itself. The learning mode can be used for all other household alarms of telephone rings, burglar alarms, carbon monoxide (CO) alarms, smoke detectors, weather alerts, etc. Various embodiments provide for automatic detection of fire alarm sounds (using an ANSI standard, for example). In another embodiment the hearing device itself can be trained to analyze such alerts and understand when to mute the stream and play the alarm or alert or an alarm or alert equivalent notification. In various embodiments, the present subject matter is used in a public multi-cast system. As a wearer of a hearing assistance device comes in the vicinity of a public broadcast service, the streaming audio from the broadcast service can be transmitted via wireless link for reception, in various embodiments.

The present subject matter also relates to communication between one or more home appliances and a hearing assistance device through the gateway device. A hearing aid user can run into issues with devices that produce audio signals to indicate their states. For example, a microwave oven may beep upon completion of a cooking task, but the beep can be difficulty to hear by a hearing aid user, particularly when the hearing aid user is listening to audio streamed to the hearing aid. One approach to addressing this difficulty is to have each of the home appliance devices communicate directly to the hearing aid. However, this requires every device to include an additional feature to make it hearing aid compatible. Lacking of coordination between the devices may lead to unreliability within a system with multiple devices independently communicating with a hearing aid regarding their operational states. The present subject matter provides a system that uses a hub device for the devices communicating with the hearing aid, such as a home automation hub that is configured to communicate with one or more home appliances.

In various embodiments, the hub device collects information from one or more home appliances and relays the information to the gateway device, which processes the information and transmits the processed information to a hearing assistance device such as a hearing aid. In various embodiments, open systems, such as the Internet and a home automation hub, are utilized to interface with the gateway device installed with proprietary software, such as an application running on an Android or iOS smartphone, which in turn connects with the hearing assistance device to update the user about the state of each appliance in his/her home. In various embodiments, an open communication protocol may also be utilized to allow the gateway device to connect to multiple smart home systems.

By allowing all communications from appliances to go through a single hub, the present subject matter eliminates the need for each individual appliance to have the capability of communicating with the hearing assistance device directly. This also provides the hearing assistance device with better and much wider access to the state of multiple appliances in a house.

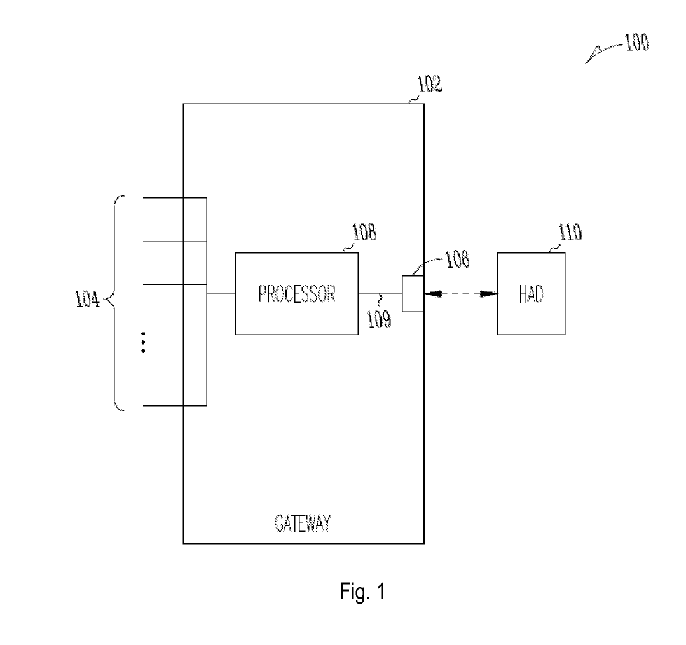

FIG. 1 illustrates a block diagram of a system for wirelessly communicating with a hearing assistance device, according to one embodiment of the present subject matter. The system 100 includes an apparatus 102, such as a gateway, for wireless communication with a hearing assistance device 110. The apparatus 102 includes one or more inputs 104 configured to receive messages and alerts directed to a wearer of a hearing assistance device. A processor 108 is configured to process the messages and alerts to obtain an output 109 adapted to be played via audio to a wearer of the hearing assistance device, and to interrupt a current audio stream being played to the wearer. A wireless transmitter 106 is configured to transmit the output to the hearing assistance device 110, in various embodiments.

In various embodiments, apparatus 102 includes one or more of the interface embodiments demonstrated in U.S. patent application Ser. No. 13/458,304, filed Apr. 27, 2012, entitled: COMMUNICATION SYSTEM FOR WIRELESS AUDIO DEVICES which claims the benefit under 35 U.S.C. §120 of U.S. patent application Ser. No. 11/447,617, filed Jun. 5, 2006, (now issued as U.S. Pat. No. 8,169,938) which claims the benefit under 35 U.S.C. §119(e) of U.S. Provisional Patent Application Ser. No. 60/687,707, filed Jun. 5, 2005, the entire disclosures of which are all hereby incorporated by reference.

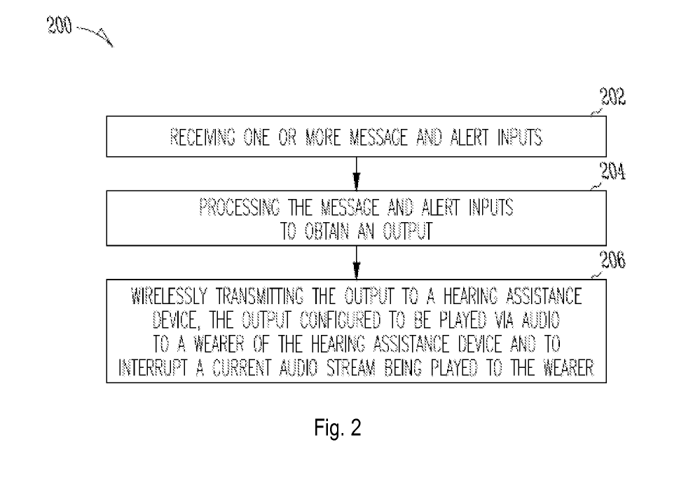

FIG. 2 illustrates a flow diagram of a method 200 for wirelessly communicating with a hearing assistance device, according to one embodiment of the present subject matter. At 202, one or more message and alert inputs are received and the message and alert inputs are processed to obtain an output, at 204. At 206, the output is wirelessly transmitted to a hearing assistance device, and the output is configured to be played via audio to a wearer of the hearing assistance device and to interrupt a current audio stream being played to the wearer, in various embodiments.

In various embodiments, a method of using a hearing assistance device is provided. The hearing assistance device includes a microphone and a processor and is adapted to be worn by a wearer, in an embodiment. The method includes analyzing an acoustic input to the microphone using the processor to determine whether the acoustic input includes an alarm indication or other alert, and attenuating a wired or wireless audio stream input to the hearing assistance device to alert the wearer about the alarm indication or other alert, in various embodiments.

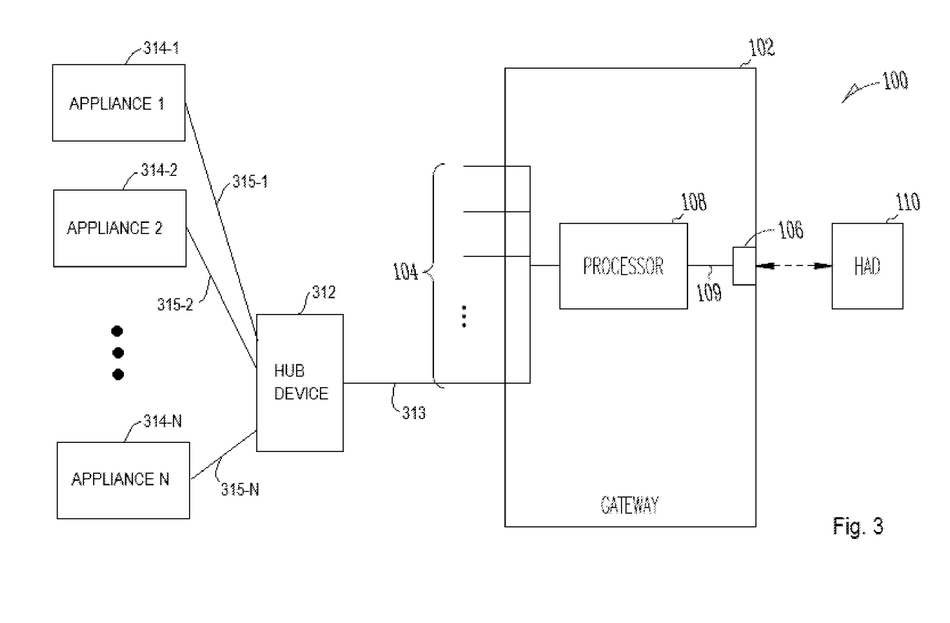

FIG. 3 illustrates a block diagram of a system 330 providing for wireless communication from one or more home appliances to a hearing assistance device, according to one embodiment of the present subject matter. System 330 includes a hub device 312 providing for an interface between one or more home appliances 314 and system 100, thus allowing for communication from one or more home appliances 314 to a wearer of hearing assistance device 110. While a plurality of home appliances 314-1 to 314-N is shown in FIG. 3 for illustrative purposes, one or more home appliances 314 may include any number of home appliances (i.e., N≧1). Examples of one or more home appliances 314 include, but are not limited to, range, oven, microwave oven, refrigerator, toaster, coffee maker, dishwasher, laundry washer, and laundry dryer.

In various embodiments, one or more home appliances 314 are each configured to transmit status information via one of one or more communication links 315. Appliance 314-1 is communicatively coupled to hub device 312 via communication link 315-1, appliance 314-2 is communicatively coupled to hub device 312 via communication link 315-2 . . . , and appliance 314-N is communicatively coupled to hub device 312 via communication link 315-N. In one embodiment, one or more home appliances 314 are each configured to transmit status information wireless using an open communication protocol, such as the Zigbee or Z-wave protocol. The status information is indicative of a status of the each home appliance. Examples of such status information include, but are not limited to, completion of a heating task of a microwave oven, door of a refrigerator remaining open for prolonged time, and a set temperature of an oven has been reached.

Hub device 312 is configured to receive the status information from one or more home appliance 314 via communication links 315, produce a status signal representative of the status information, and transmit the status signal to apparatus 102, such as the gateway device, via communication link 313. The status signal represents the status information. In one embodiment, hub device 312 is a home automation hub. Hub device 312 is a center into which all of one or more home appliance 314 are tied, and provides an interface between the one or more home appliance and apparatus 102.

In various embodiments, apparatus 102 includes a wireless gateway device. In various embodiments, the wireless gateway device is implemented in a cellular phone including a smartphone, a computer, a cell phone/entertainment device (CPED), or any gateway device discussed in this document. In one embodiment, hub device 312 is physically integrated into apparatus 102. In other embodiments, hub device 312 and apparatus 102, such as the wireless gateway device, are physically separate devices.

In one embodiment, apparatus 102 includes one or more inputs 104 configured to receive the status signal from hub device 312, such as via a wired link or a wireless link. Processor 108 is configured to process the status signal to produce output 109. Output 109 is adapted to be played via audio to the wearer of hearing assistance device 110. In one embodiment, output 109 is further adapted to interrupt a current audio stream being played to the wearer of hearing assistance device 110. In one embodiment, processor 108 is configured to make intelligent decisions when processing the status signal, such as selectively providing status information to the wearer using predetermined or user-selected criteria. This allows the wearer to decide, for example, which appliance(s) to monitor and/or which state(s) to be informed.

In an example of application of system 330, smart microwave oven connects to a home automation hub (e.g., the SmartThings Hub by SmartThings, Washington, D.C.) to transmit its state. When the microwave oven completes a cooking task, it sends an alert signal to the hub, which relays the alert signal to the wireless gateway device. The gateway device in turn informs the wearer through a hearing aid. This allows a hearing aid wearer to be confident in knowing when the cooking is done.

In one embodiment, system 330 can be combined with a geo-location system to warn the wearer of the hearing assistance device when the wearer leaves home with certain appliances, such as range or oven, on. While the wearer can be alerted to this on a smartphone itself, considering the fact that the broad demographic of the wearers are part of the older generation, they will likely pay more attention to something their hearing aids are telling them.

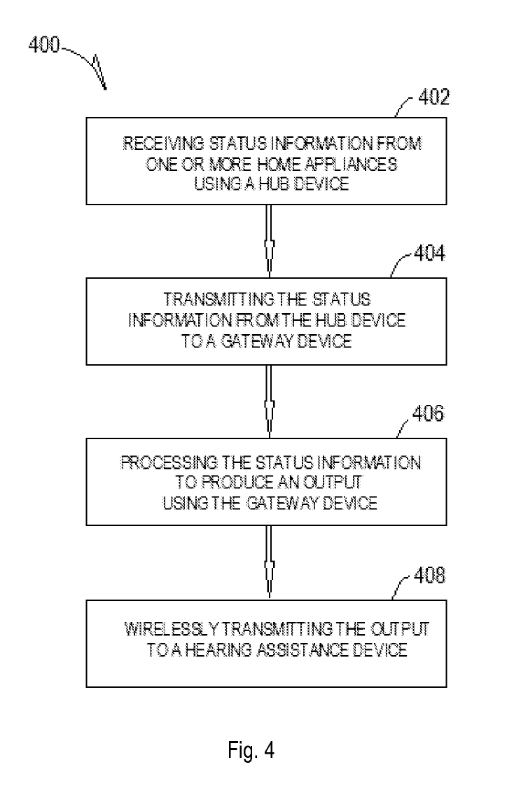

FIG. 4 illustrates a flow diagram of a method 400 for wireless communication between one or more home appliances and a hearing assistance device, according to one embodiment of the present subject matter. In one embodiment, system 300 is configured to perform method 400.

At 402, status information from the one or more home appliances is received using a hub device. The status information is indicative of a status of each home appliance of the one or more home appliances. In one embodiment, the status information is wirelessly transmitted from the one or more home appliances using an open communication protocol, such as the Zigbee or Z-wave protocol.

At 404, the status information is transmitted from the hub device to a gateway device. In one embodiment, the status information is transmitted from the hub device to a gateway device via a wired link. In another embodiment, the status information is transmitted from the hub device to a gateway device via a wireless link. Examples of the gateway device include, but are not limited to, cellular phone, smartphone, and computer with an application software providing for interface with the hearing assistance device.

At 406, the status information is processed to produce an output using the gateway device. The output is adapted to be played via audio by the hearing assistance device to the wearer. In one embodiment, the output is further adapted to interrupt a current audio stream being played by the hearing assistance device to the wearer. In one embodiment, the status information is processed to produce an output selectively relaying the status information to the wearer of the hearing assistance device.

At 408, the output is wirelessly transmitted from the gateway device to the hearing assistance device. The output is played via audio by the hearing assistance device to its wearer.

In various embodiments, the present subject matter allows wearers of hearing assistance devices more comfortable at home. It will also make hearing assistance devices such as hearing aids compatible with home automation systems.

Various embodiments of the present subject matter support wireless communications with a hearing assistance device. In various embodiments the wireless communications can include standard or nonstandard communications. Some examples of standard wireless communications include link protocols including, but not limited to, Bluetooth™, IEEE 802.11(wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications. Although the present system is demonstrated as a radio system, it is possible that other forms of wireless communications can be used such as ultrasonic, optical, and others. It is understood that the standards which can be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fibre-channel, Firewire or 1394, InfiniBand, or a native streaming interface. In various embodiments, such connections include all past and present link protocols. It is also contemplated that future versions of these protocols and new future standards may be employed without departing from the scope of the present subject matter.

It is understood that variations in communications protocols, antenna configurations, and combinations of components may be employed without departing from the scope of the present subject matter. Hearing assistance devices typically include an enclosure or housing, a microphone, hearing assistance device electronics including processing electronics, and a speaker or receiver. Processing electronics include a controller or processor, such as a digital signal processor (DSP), in various embodiments. Other types of processors may be used without departing from the scope of this disclosure. It is understood that in various embodiments the microphone is optional. It is understood that in various embodiments the receiver is optional. Antenna configurations may vary and may be included within an enclosure for the electronics or be external to an enclosure for the electronics. Thus, the examples set forth herein are intended to be demonstrative and not a limiting or exhaustive depiction of variations.

It is understood that the hearing aids referenced in this patent application include a processor. The processor may be a digital signal processor (DSP), microprocessor, microcontroller, other digital logic, or combinations thereof. The processing of signals referenced in this application can be performed using the processor. Processing may be done in the digital domain, the analog domain, or combinations thereof. Processing may be done using subband processing techniques. Processing may be done with frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, and certain types of filtering and processing. In various embodiments the processor is adapted to perform instructions stored in memory which may or may not be explicitly shown. Various types of memory may be used, including volatile and nonvolatile forms of memory. In various embodiments, instructions are performed by the processor to perform a number of signal processing tasks. In such embodiments, analog components are in communication with the processor to perform signal tasks, such as microphone reception, or receiver sound embodiments (i.e., in applications where such transducers are used). In various embodiments, different realizations of the block diagrams, circuits, and processes set forth herein may occur without departing from the scope of the present subject matter.

The present subject matter can be used for a variety of hearing assistance devices, including but not limited to, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user. Such devices are also known as receiver-in-the-canal (RIC) or receiver-in-the-ear (RITE) hearing instruments. It is understood that other hearing assistance devices not expressly stated herein may fall within the scope of the present subject matter. Further, the present subject matter can be used for persons without hearing impairment that may be using wireless, or wired headphone and earbud devices for listening to audio streams.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system for communication between one or more home appliances and a wearer of a hearing assistance device, the system comprising:
a hub device configured to receive status information from the one or more home appliance, produce a status signal representative of the status information, and transmit the status signal, the status information indicative of a status of each home appliance of the one or more home appliance; and
a gateway device including:
an input configured to receive the status signal from the hub device;
a processor configured to process the status signal to produce an output adapted to be played via audio by the hearing assistance device to the wearer; and
a wireless transmitter configured to transmit the output to the hearing assistance device.

2. The system of claim 1, wherein the processor is configured to produce the output that is further adapted to interrupt a current audio stream being played by the hearing assistance device to the wearer.

3. The system of claim 1, wherein the hub device and the gateway device are integrated with each other into a single device.

4. The system of claim 1, wherein the input of the gateway device is configured to wirelessly receive the status signal from the hub device.

5. The system of claim 4, wherein the hub device is configured to receive status information wirelessly transmitted by each appliance of the one or more home appliances using an open communication protocol.

6. The system of claim 5, wherein the hub device is configured to receive status information transmitted by the each appliance using a Zigbee or Z-wave protocol.

7. The system of claim 6, wherein the hub device comprises a home automation hub configured to receive status information from a plurality of appliances of the one or more home appliances.

8. The system of claim 4, wherein the gateway device comprises a cellular phone.

9. The system of claim 4, wherein the gateway device comprises a computer.

10. A method for providing communication from one or more home appliances to a wearer of a hearing assistance device, the method comprising:
receiving status information from the one or more home appliances using a hub device, the status information indicative of status of each home appliance of the one or more home appliances;
transmitting the status information from the hub device to a gateway device;
processing the status information to produce an output using the gateway device, the output adapted to be played via audio by the hearing assistance device to the wearer; and
wirelessly transmitting the output to the hearing assistance device.

11. The method of claim 10, wherein processing the status information to produce the output using the gateway device comprises processing the status information to produce an output adapted to be played via audio by the hearing assistance device to the wearer and to interrupt a current audio stream being played by the hearing assistance device to the wearer.

12. The method of claim 10, wherein receiving the status information from the one or more home appliances using the hub device comprises receiving the status information wirelessly transmitted from the one or more home appliances using an open communication protocol.

13. The method of claim 12, wherein receiving status information from the one or more home appliances using the hub device comprises receiving status information from a plurality of home appliances using the hub device.

14. The method of claim 13, wherein processing the status information to produce the output using the gateway device comprises processing the status information to produce an output selectively relaying the status information to the wearer.

15. The method of claim 11, wherein transmitting the status information from the hub device to the gateway device comprises wirelessly transmitting the status information from the hub device to the gateway device.

16. The method of claim 15, wherein wirelessly transmitting the status information from the hub device to the gateway device comprises wirelessly transmitting the status information from the hub device to a cellular phone configured to be the gateway device.

17. The method of claim 15, wherein wirelessly transmitting the status information from the hub device to the gateway device comprises wirelessly transmitting the status information from the hub device to a computer configured to be the gateway device.

18. A method for providing an interface between one or more home appliances and a hearing assistance device, the method comprising:
receiving status information wirelessly from a hub device communicatively coupled to the one or more home appliances, the status information indicative of status of each home appliance of the one or more home appliances;
processing the status information to produce an output adapted to be played via audio by the hearing assistance device, the output selectively relaying the status information to the hearing assistance device; and
wirelessly transmitting the output to the hearing assistance device.

19. The method of claim 18, wherein processing the status information to produce the output comprises processing the status information to produce an output adapted to be played via audio by the hearing assistance device and to interrupt a current audio stream being played by the hearing assistance device.

20. The method of claim 19, wherein the receiving, processing, and wirelessly transmitting comprise receiving, processing, and wirelessly transmitting using a smartphone.
